(19) United States
(12) Patent Application Publication
(10) Pub. No.: US 2006/0282441 A1
(43) Pub. Date: Dec. 14, 2006

(54) Definition and management of procedures in a distributed environment

(76) Inventors: Dan Weller, Palo Alto, CA (US); Dan Hardy, Berkeley, CA (US); Jim Wanderer, Palo Alto, CA (US); Leslie Chan, San Francisco, CA (US)

Correspondence Address: HELLER EHRMAN LLP, 275 MIDDLEFIELD ROAD, MENLO PARK, CA, 94025-3506, US

(21) Appl. No.: 11/401,499

(22) Filed: Apr. 6, 2006

Related U.S. Application Data
(60) Provisional application No. 60/669,288, filed on Apr. 6, 2005.

(51) Int. Cl. G06F 7/00

(52) U.S. Cl. 707/100

(57) ABSTRACT

A procedure management system and methods for its operation are disclosed. The methods disclosed include the ability to capture procedure definitions in the system, to improve on the procedure content by associating feedback and comments with the procedure definitions, and to store these procedure definitions in a database. Additional disclosures include the ability to display and interactively use the procedures, to track and record status of each step outcome of the procedure and to suspend and later resume a procedure run. In addition, methods are disclosed that enable the user of a procedure to be notified of any changes that have occurred in a procedure definition since it was last used. Other embodiments include methods that allow users to audit the procedure definition and outcome information. In addition, a procedure authoring tool is disclosed, which enables version tracking of procedure definitions and tracks what has changed between each version.

### CROSS-REFERENCE TO RELATED APPLICATIONS

This application claims the benefit of U.S. Ser. No. 60/669,288, filed Apr. 6, 2005, which application is fully incorporated herein by reference.

### BACKGROUND OF THE INVENTION

1. Field of the Invention

This invention relates generally to systems, and methods, for defining, using and managing company procedures, processes how to's or checklists, and ensuring that they are kept accurate and consistent, and more particularly to systems, and methods for tracking the status of each procedure execution, storing the outcome information in a relational database, enabling audits of this information to be performed.

2. Description of the Related Art

Most companies execute procedures on a daily basis. Procedures define how to accomplish a task. They consist of the set of steps or instructions that define what needs to be done. Procedures are defined in all areas of a company, including but not limited to finance, human resources, IT, marketing, sales, and the like. By way of illustration, and without limitation, in the area of IT management examples of procedures can be the steps taken to upgrade the operating system on a machine, to install new software, and the like. Management and maintenance of company procedures is a task that often gets overlooked. The procedures definitions may be kept in a network share drive or in a binder—users have a hard time finding them when they need them. The definitions do not get updated as changes occur in the company and so are often out of date. There is no record kept of when a procedure is executed, by whom it was executed, or the result of the execution. Problems occur as a result of not following all of the procedure steps or following incorrect procedure definitions. These problems are costly to the company. In addition to the problems companies have with following company procedures, companies today are audited for compliance with certain standards. Companies need a better way to track what company procedures get run, who is responsible for running said procedures, and the ability to audit or report on the results what has changed.

There is a need for a procedure management system that enables management, maintenance, usage and storage of procedure definitions. The system needs to allow users to define procedures; and to keep these procedure definitions accurate by enabling feedback on the procedure definitions. There is a need for a system that allows users to use and track the use of these procedures. This usage .information should be available to audit. There is a need for a system that enables users to suspend and resume the execution of procedures; important steps in a procedure will not be omitted as the system will ensure that users can resume execution exactly where they left off.

### SUMMARY OF THE INVENTION

An object of the present invention is to provide a system, and methods, that enables users to define, maintain, use and store procedure definitions and procedure usage information.

Another object of the present invention is to provide a system, and methods, for interactively guiding a user through using the procedures and enables the user to suspend and later resume the execution of any procedure in the system.

These and other objects of the present invention are achieved in, a procedure management system that includes a host server. The host server is configured to allow a user operating a web browser to define a procedure. The procedure has a name, a description and a list of steps required to achieve a specific task. A procedure management server processes a procedure definition into a procedure structure that is retrievable by the host server and allows the user to run the procedure and provide feedback on the procedure definition. A database server includes a run time database for procedure information and a definition database for procedures. The database server is configured to communicate with the procedure management server.

In another embodiment of the present invention, a method is provided for allowing a user operating a web browser to define a procedure that has a name, a description and a list of steps required to achieve a specific task. Each step of a procedure is defined. The procedure definition is stored in a database.

### BRIEF DESCRIPTION OF THE DRAWINGS

FIG. 1 is a block diagram for a procedure management system in one embodiment of the present invention.

FIG. 2 is one embodiment of a login page to a procedure management system.

FIG. 3 is one embodiment of a procedure definition in a procedure management system.

FIG. 4 is one embodiment of a procedure definition displaying different step element types.

FIG. 5 displays a flowchart outlining how procedures are stored to the database.

FIG. 6 displays one embodiment of how a running procedure could be displayed to the end user.

FIG. 7 shows one embodiment of how a procedure can be displayed to the user in an isolated workspace of their desktop.

FIG. 8 displays a flowchart representing how comments can be added to a procedure definition.

FIG. 9 displays one embodiment of a dialog that could be used to add feedback or comments to a procedure definition.

FIG. 9 is a flowchart outlining how comments are added to procedure definition.

FIG. 10 displays one embodiment of how the revision history of a procedure could be displayed to the user.

FIG. 11 displays one embodiment of how changes in a procedure definition can be displayed to the user of the system.

FIG. 12 is one embodiment of a dialog that alerts a user of the system to the fact that a procedure has changed since they last used it.

FIG. 13 is a flowchart representing how the system checks for updates in a procedure definition.

FIG. 14 displays the flow for how the system reads and interprets the procedure definition from the database.

FIG. 15 outlines a flowchart of how an active procedure can be suspended or resumed in the system.

FIG. 16 displays one embodiment of a procedure editing application.

### DETAILED DESCRIPTION OF SPECIFIC EMBODIMENTS

Glossary

The following is a glossary of some terms used in this invention.

Procedure: A set of well defined steps required to implement a process or how-to do something.

Procedure Owner: Person responsible for definition and maintenance of a procedure.

Procedure Instance: An occurrence or run of a defined procedure. Several users may run a procedure in which case each user has their own instance of the procedure.

Procedure Definition Database: A database where procedure definition information is stored.

Procedure Runtime Database: A database where procedure runtime information is stored.

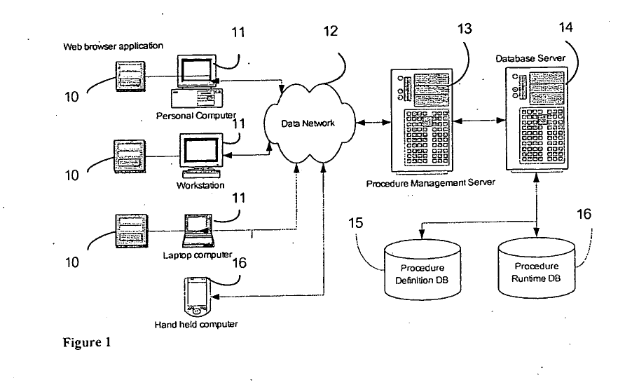

FIG. 1 shows a hardware configuration for one embodiment of the invention. The procedure management server 13 and database server 14 may be the same or physically separate computers connected by a network 12, which may be a local area network or a wide area network. Users access the procedure management server by running a web based application 10 on their personal computer 11, workstation 11 or laptop 11. In addition users can access the data from the procedure management server by using a handheld device 16. Procedure definitions are stored in a database 15 from herein referred to as the procedure definition database. Procedure run time information is stored in a database 16, from herein referred to as the procedure runtime database. The runtime database may be the same or different database from the procedure definition database, and these databases may reside on the same or different database server machine. The procedure management server 13 reads the procedure definitions from the database server 14 and displays to the user using a web based application 10.

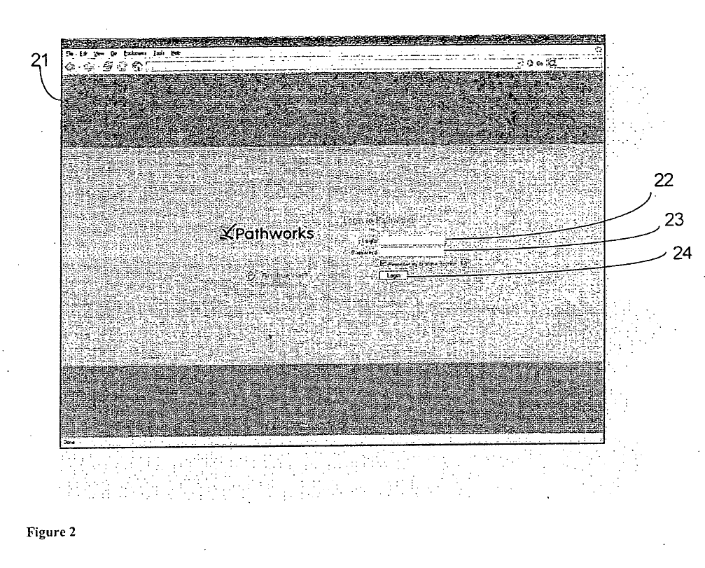

The user accesses the procedure management system from their web browser to use the system. FIG. 2 shows one embodiment of a login page 21. The user provides a username 22 and password 23 to access the system 24. The system maintains an account for each user, which defines the user's capabilities for viewing, updating and executing the procedures stored in the system. The system will validate the username and password and only authorized users are able to access the system. The procedure management system will only display those procedures that the user has rights to view to the user. Only authorized users are allowed to update procedures with feedback received on their content. For example, the manager of the IT department may have access to all the procedures in his department, but may only have view access to the procedures in the Human Resources department. The manager can update and respond to feedback on the procedures he is responsible for, but may only use and provide feedback on those in the Human Resource department.

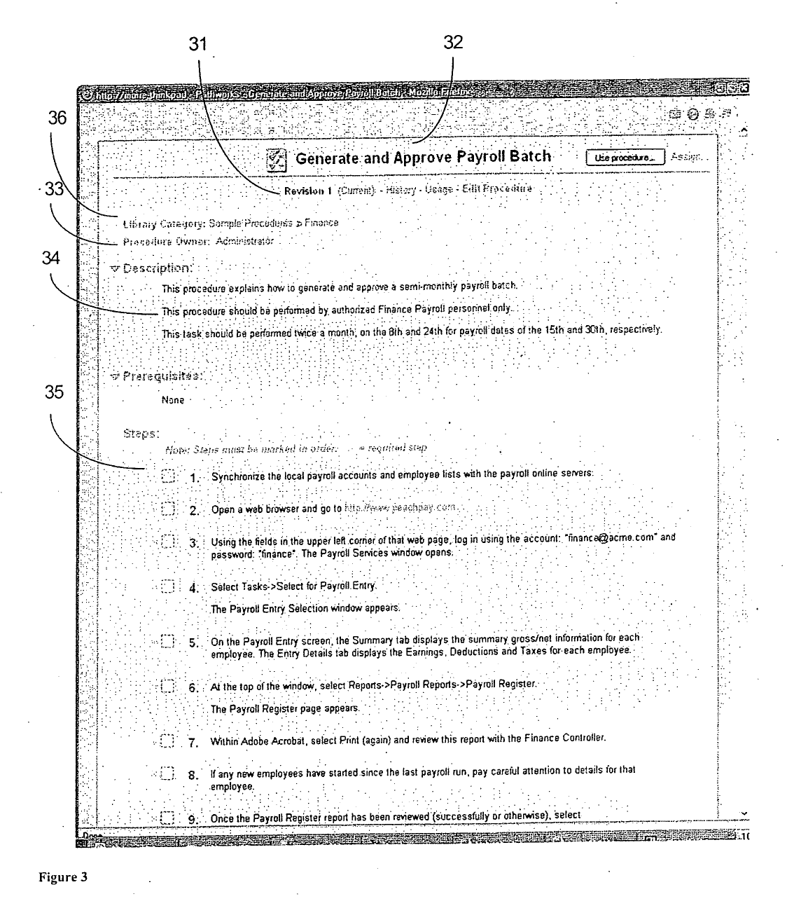

The invention provides methods to enable the user to capture the steps needed to define a procedure, process or how to do something in the system. Procedure information is captured into a procedure structure and stored in the procedure definition database. By way of illustration and referring now to FIG. 3, one embodiment of a visual representation of a procedure structure is displayed. A procedure structure can include a variety of information, including but not limited to, the name 32 and description 34 of the procedure, a summary 34 outlining the purpose of the procedure, the owner 33 or author 33 of the procedure, the category 36 of the procedure, the date the procedure was created and last modified, the current version 31 and the current state 31 of the procedure. The access rights of the procedure owner 33 will determine what library categories 36 they have access to. The system defines a flexible access control that ensures that users only will see and execute procedures in the system that they have rights to view. A procedure can have several defined states, including but not limited to, draft, current, or obsolete. In addition, a procedure definition will contain a series of steps 35 or actions that define how to perform a procedure.

In one embodiment of the present invention, the procedure structure is expanded to include entry and exit actions for each step. These actions include but are not limited to, conditional, computational, plug-in, script, go to, termination actions, and the like. By way of illustration, and without limitation, examples of this include, branch to subsequent steps based on values entered or returned via execution of a process (conditional), obtain the value of an expression (computational), call a external process (plug-in), execute a script (script), skip steps and go to a step further down in the procedure definition (go-to action) or to determine that this procedure can not be completed as is, terminate the execution (termination action), and the like.

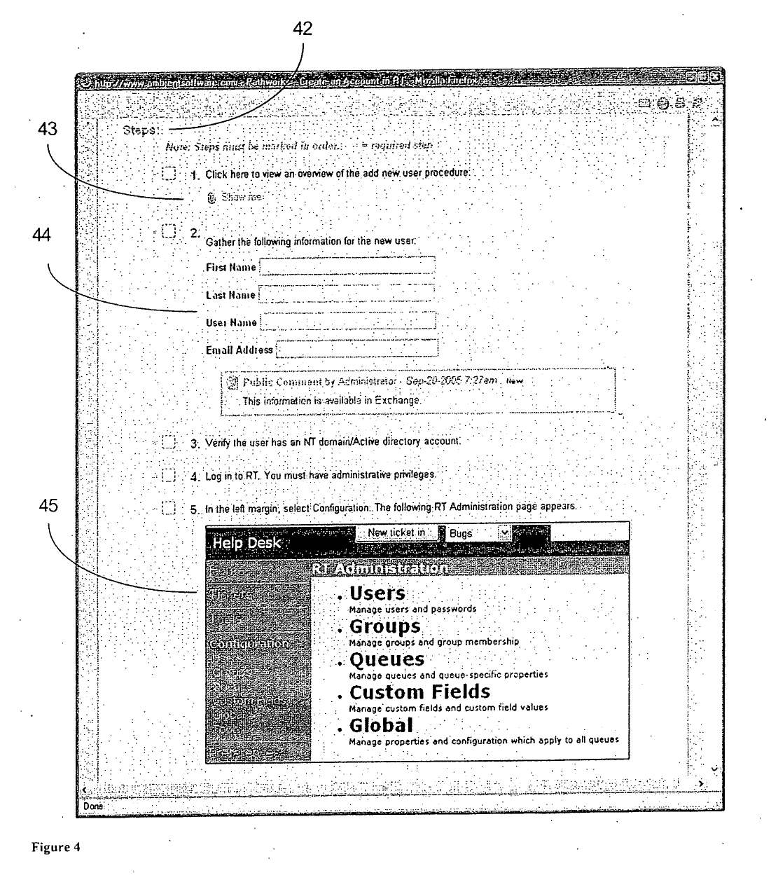

In another embodiment of a procedure structure, the element of a step is extended to allow the author to associate prompts, text, images or attachments with each step. By way of illustration, and without limitation, this includes display of information to the user in a variety of formats (text or images), display requests asking the user to perform certain actions (prompts), obtaining responses from the user and using those responses to determine the next or future appropriate actions, perform actions automatically on behalf of the user, alerting (via email or other mechanism) when certain actions are performed or not performed by the algorithm or by the user, and the like. In addition, each step can contain sub steps that in turn contain any of the information outlined above. The step and sub step elements are defined and stored with the procedure definition. Referring now to FIG. 4, one embodiment of a procedure structure definition with such step elements is displayed. The procedure steps 42 include a step with an associated audio video file 43, prompts for information from the user 44 and an image or screenshot 45 that can assist the user in completing the procedure.

The system provides methods to allow users to define these procedures in the system. In one embodiment of the invention, a web browser application enables users to define and capture the procedure definition as detailed above. The application provides methods to define the procedure structure information—name, description, category, owner, and the like. In addition, methods are provided where the individual steps and associated step actions of the procedure are defined. Steps can be added, moved or deleted from the procedure definition. Step properties can be defined for each step. By way of example and without limitation, step properties include marking the step for sequential or non-sequential execution or making procedure steps optional or required. The web application communicates with the procedure management server to store the procedure definition in the procedure definition database. The procedure definition is written in a markup language, referenced from herein as Procedure Markup Language or PML. This language defines a procedure structure and methods are provided that write the PML definition of a procedure to the database. PML is an XML document format, the structure of which is defined by an XML schema. The schema describes the structure and format of a procedure, that it can contain steps, sub-steps, step elements, step actions, and the like.

In another embodiment of the invention, the ability to test the validity of the procedure definition is provided. Users of the system can define their procedure and execute the procedure in ‘test mode’ to verify the validity of each step and step action that is defined. By way of illustration, a procedure might define a step action to notify the manager of the group on a failure of a specific step. Running in test mode, the notification will not be sent but a message or similar notification will be displayed to inform the user of the action that would be performed.

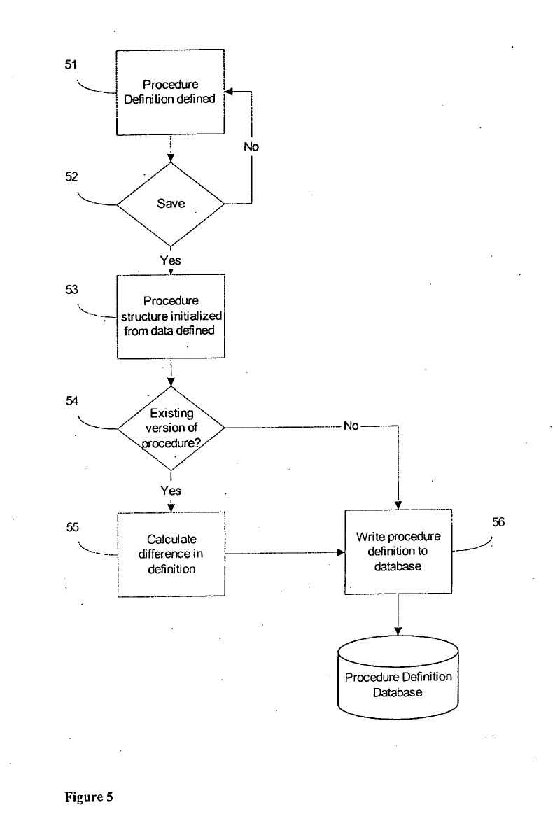

In a specific embodiment of the invention, methods are defined to store the said procedure definitions in the procedure definition database. Referring now to FIG. 5 a flowchart of this process is outlined. By way of example, and without limitation, the procedure definition is authored using a web based application 51. The procedure definition is captured and parsed into the various components of the procedure structure 53, including but not limited to, procedure name, description, set of steps, author, and the like. The system checks if this is a new procedure definition or an update to an existing procedure definition 54. A method is defined which will check the procedure definition database for existence of a procedure of the defined name in the defined procedure category. If no procedure definition is found, the procedure definition is written to the database 56 as a new procedure and assigned a procedure version number. If an existing procedure is found, a new revision of the existing procedure definition is created. The system will calculate what has changed between the new and existing procedure revisions 55 and store both the old and updated procedure definition in the procedure definition database.

In this embodiment of the invention, the procedure structure is extended to contain procedure revision information. Procedure revision information will capture the version of each procedure definition. By way of example, and without limitation, each time a new revision is created the procedure version can be incremented. In addition timestamps for when each procedure definition was updated and by whom can be stored with the procedure definition. The procedure revision information provides the ability to store procedure content of older procedure revisions. The system defines methods that enable the display of differences in procedure versions to the users.

In another embodiment of the system, an algorithm is defined that will parse the procedure definition information stored in the procedure definition database, recreate the procedure structure and using a web based application present the procedure steps to the user as an interactive checklist of steps. The algorithm will read the current version of the procedure definition from the database and by default display the most recent revision to the user of the system. Methods are provided that enable the user to view what has changed between different revisions of the procedure definition.

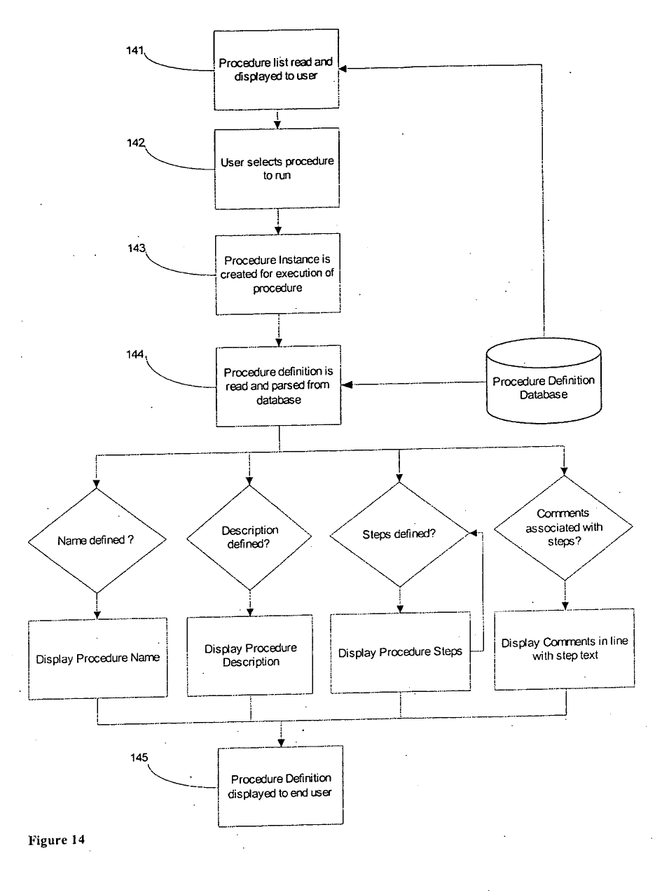

The procedure library is where the procedure definitions are stored by the system. The procedure definitions are stored in the procedure definition database and displayed to the user based on their access rights. Referring now to FIG. 14, an algorithm is provided to read and interpret the procedure definition. The algorithms implement a read and parse of the procedure definition from the database and visually present it to the user. By way of example, and without limitation, a list of all available procedures is displayed to the user 141. The user selects the procedure they want to display or run 142. A procedure instance for each invocation of the procedure is created and tracked 143. The procedure definition is read from the database 144. The definition is parsed for display to the user, the procedure name, description, set of steps and comments associated with the steps are read and displayed to the user 145.

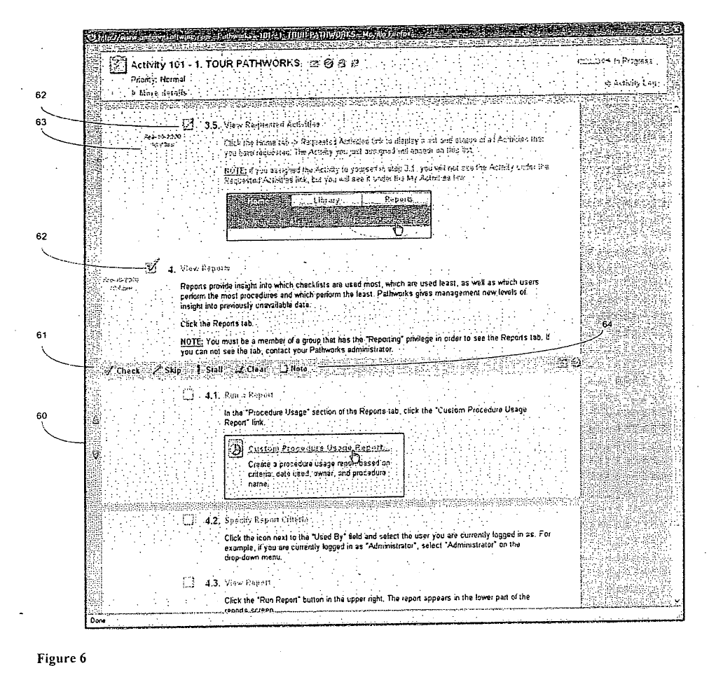

The system defines methods to present the procedure definition to the user using a web based application. Referring now to FIG. 6, one embodiment of such a visual presentation is shown. In this example the procedure is presented to the user as an interactive checklist. The system defines methods that allow the user to sequence through the steps of the procedure, perform actions on procedure steps and mark the outcome of procedure steps. In this example, a graphical slide ruler interface 60 highlights the current step-to the user and presents a set of actions 61 that can be performed on each step. By way of illustration, and without limitation, the actions that can be performed include marking the step outcome, clearing the step outcome, or adding a note to the procedure step. By way of example, a step outcome could be that the step was completed 61, stalled 61 or skipped 61. A visual representation of the outcome of each step is presented 62 to the user. In this example, the steps in a procedure can be viewed as a checklist of steps and sub steps with a set of actions available. The user can sequence through these steps and with a single mouse click mark the status of the step. Once a step is marked as completed or skipped, the graphical slider 60 will advance to the next step of the procedure, enabling the user to always know exactly where in the execution of the procedure they are.

In yet another aspect of the invention, the system defines methods to record the step outcome of each step 62 and timestamp 63 when each step action is performed. This information is saved for each invocation of the procedure and is written to the procedure runtime database. This information provides an audit trial of what action occurred on each step of the procedure, when it happened and by whom it was performed. Methods are disclosed which enable the users to see a log of the activity on a procedure and to run reports on this information.

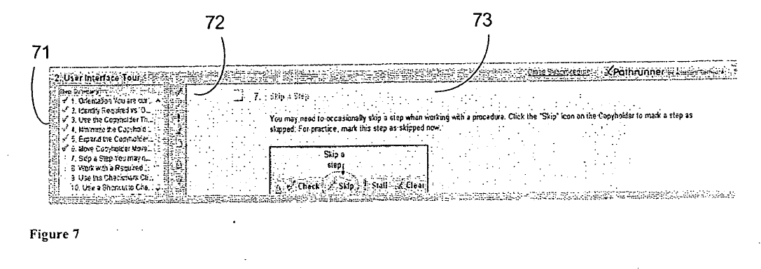

In yet another aspect of the invention, the procedure definition can be presented to the user in a workspace isolated from the user's desktop. By way of example, and without limitation, a portion of the user's screen can be reserved in order for the procedure definition to be displayed and used. In this embodiment, a workspace is created on the user's screen that is isolated from the rest of the user's desktop. This workspace is utilized by the user to perform actions on steps of the procedure. The workspace remains visible on the user's screen to provide for the user to see the step of a procedure that the user is currently on. As illustrated in FIG. 7, the workspace can display a procedure overview 71 that outlines the procedure name and steps in one panel. By way of example, FIG. 7 shows the other panels displaying the current and previous steps 73 in the procedure definition. The user can mark a step status 72 as they iterate through the steps of the procedure. By way of example, and without limitation, this could be to mark the step as completed, stalled or skipped. The system provides methods to remember the current step of the procedure. This provides that if the workspace is closed, and the procedure later resumed, it will continue where it left off.

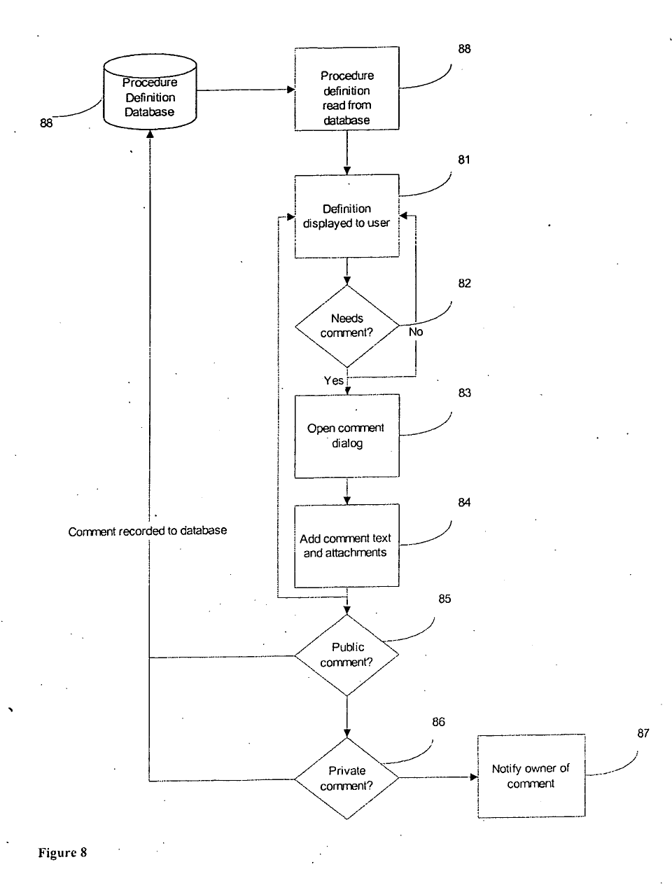

In this embodiment of the present invention, a procedure definition that has been defined and published is accessible to users of the system. A method is defined that allows users to attach comments or notes to a procedure definition. In the current embodiment, all comments associated with the procedure definition are tracked and recorded in the database. Each step of a procedure definition can optionally have associated comments written by users of the procedure, which indicate requested comments, changes or updates to the procedure definition. By way of illustration, this can be equivalent to a user attaching a post-it to a hard copy document to provide feedback. This feedback is captured by the system and stored with the procedure definition. The system provides methods to determine who can view and respond to this feedback. By way of example and without limitation, comments may be marked as publicly viewable by all users, or may be marked as private for procedure owners only. Referring now to FIG. 8, the procedure definition is read from the data store 88 and visually displayed to the end user 81. The user selects to enter a comment 82 and the comment dialog is displayed 83 to the end user. The user enters comment text 84 and can associate optional attachments 84 with the comment. The comment text and attachments are stored in the database 88. The system defines methods that determine who can view the feedback. By way of example, this could be all users of the procedure if the public option was selected or just the procedure owners if private feedback was selected. If private feedback is selected 86 the procedure author is notified of the feedback 87. The procedure author can review and update the procedure definition as appropriate. This ensures that the procedure definition is kept accurate and up to date. Improvements and updates are incorporated into the procedure definition and stored in the database.

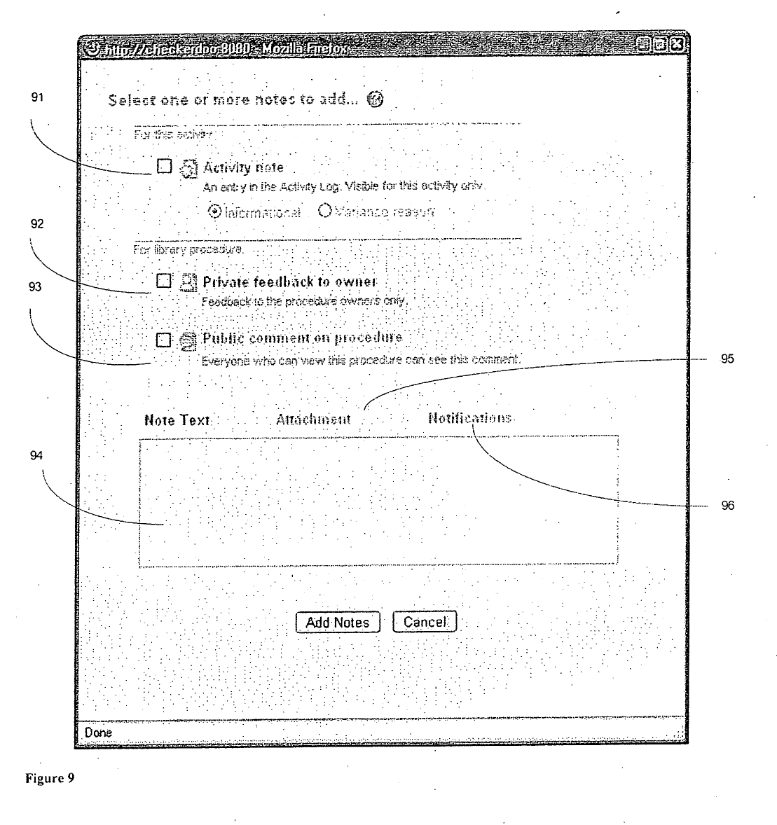

By way of illustration and referring to FIG. 6, the procedure definition is read from the database and displayed to the user. The user can choose to add * feedback to the procedure by selecting the note icon 64 option from the toolbar of the graphical slider 61. By way of example, this could open a dialog similar to that displayed in FIG. 9. The user of the invention can enter a textual comment 94 for any procedure step. By way of illustration and without limitation, comments can include optional attachments 95. The system provides the capability for the user to make the comment publicly visible 93, whereby all users of the procedure can view the comment or private 92, whereby only the author of the procedure can view the comment. Methods are defined that enable notifications to be sent out as appropriate 96, author only or all users, based on the options selected by the user.

In another embodiment of the present invention, any changes made to a procedure definition are tracked in the procedure database server. Procedure changes may be made as a result of responding to a comment from a user or a change in the environment which warrants an update to the procedure definition. By way of example, and without limitation, the procedure revision is incremented each time a new procedure is published. The procedure definition is stored for each procedure revision defined which enable procedure differences between any procedure revisions in the system to be calculated and displayed to the user. In addition, the system will store additional procedure revision information in the procedure definition database. By way of example, and without limitation, such information could be when each revision of the procedure was published, last modified and by whom it was modified. This enables tracking version and approval states of the current procedure, as well as older revisions and proposed future revisions. In addition, this enables the recreation of a procedure as it existed in the past using the information present in the database.

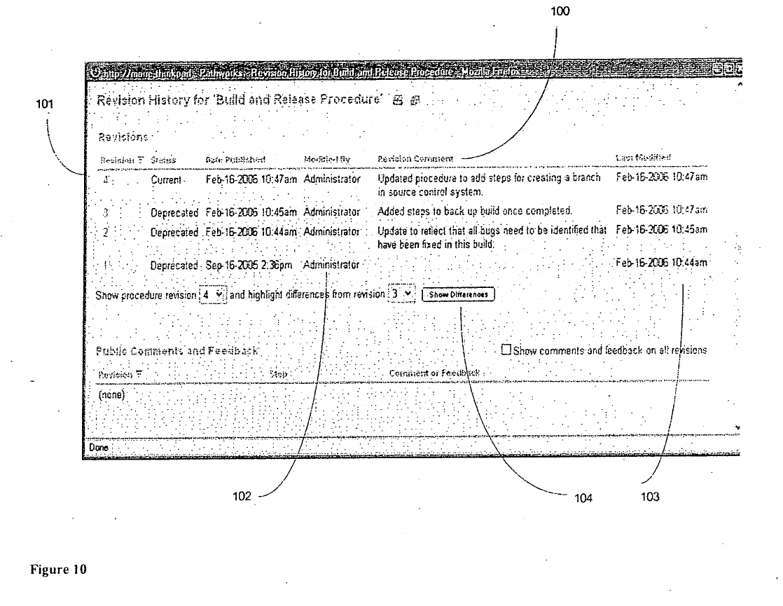

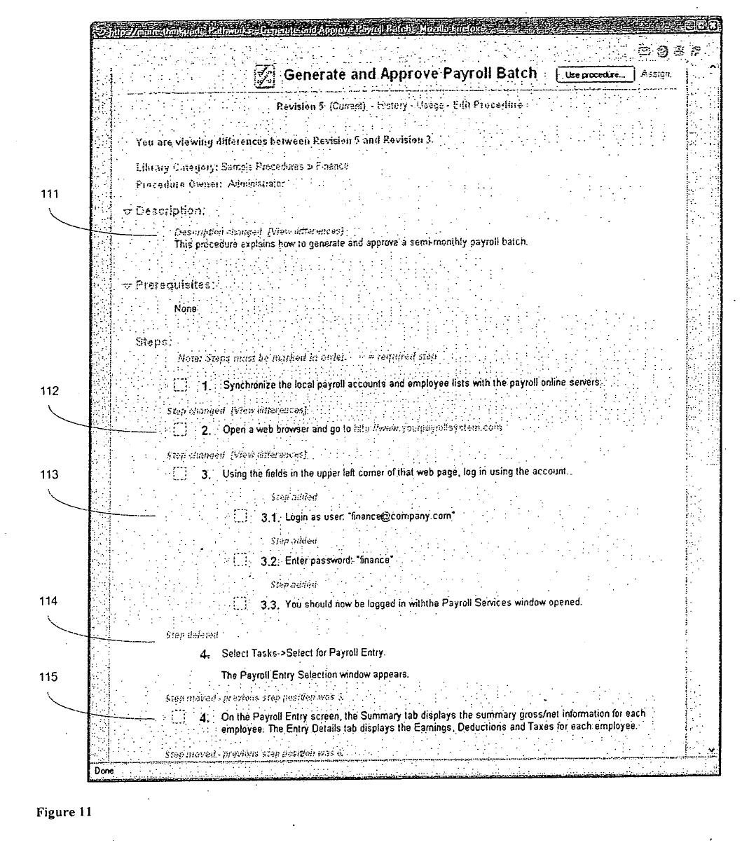

The system provides methods to ensure that the most recent procedure definition is available to users of the system. If the procedure definition is changed by the author, a new revision of the procedure is created and the older revision archived. Referring now to FIG. 10, one embodiment of how the procedure revision history could be displayed to the user is shown. By way of illustration, each version of the procedure is listed 101 along with revision comments that were captured 100 when the procedure definition was changed. Additional information such as who modified the procedure 102 and when the modifications occurred 103 are stored by the system. The user can select to see what has changed between any two versions of the procedure 104. The system will calculate the procedure differences and display to the user using a web based application. FIG. 11 is one embodiment of how the differences in procedure definition could be displayed to the user. By way of example, steps that have been added 113, deleted 114, moved 115 or changed 112 are tagged. The detailed information on exactly what has changed is stored by the system and can be viewed by the user. By way of example, and referring to FIG. 11, the web application displays a ‘View differences’ link to the user that if selected will display the step differences to the user 112. Users of the system are given an accurate step by step detail of all changes in the procedure definition since they last used the procedure. The system proactively presents changes in the procedure definitions inline to the end user, thereby preventing the users from performing invalid steps of a procedure.

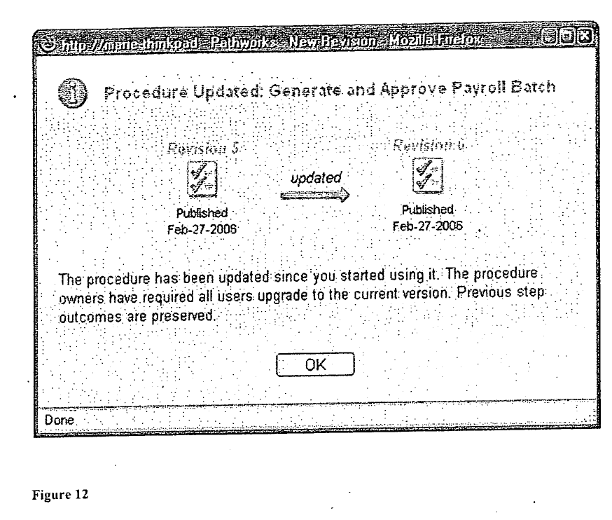

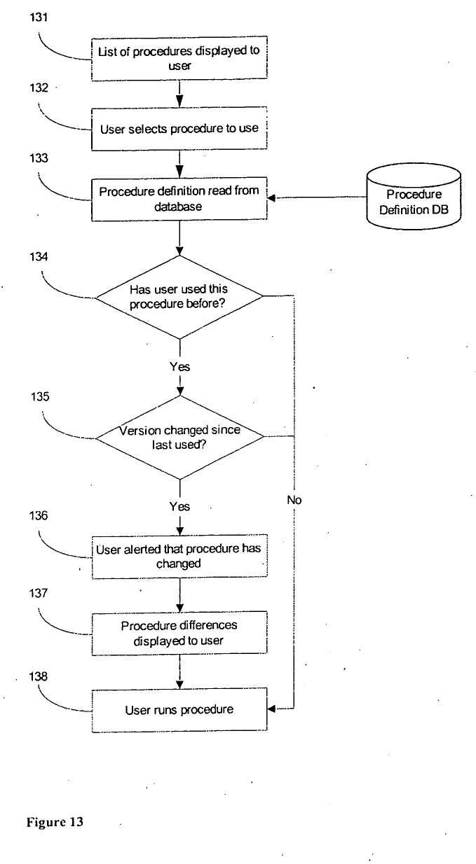

In another embodiment of the invention, the system provides methods to alert users to changes in the procedure definition if it has changed since they last used it. By way of illustration and referring now to FIG. 12, one embodiment of such a dialog presented to the end user to alert them to the fact that the procedure definition has changed is displayed. The system maintains a record of each procedure used by each user of the system. The system checks if a user has previously run a procedure, and if it has changed alerts the users that a later version exists. If the user had started to use the procedure, methods are provided to preserve previous step outcomes. In this embodiment and referring now to FIG. 13, a user of the system is presented with a list of procedures available for them to use 131. The user selects a procedure 132, and the system reads the procedure definition from the procedure definition database 133. The system checks if the user has used this procedure previously 134, and if so checks the version of the procedure that was used 135. If the procedure has not changed, the user will run the current version of the procedure 138. If the system detects that the procedure has changed 136, the user is alerted to this fact and is given the option to view the procedure changes in line. The user can interactively see what has changed in the procedure definition as they sequence through the procedure steps. This ensures that users of the system will notice changes that have occurred in the procedure definition, and eliminates users making errors by executing old instructions. Referring again to FIG. 11, one embodiment of how the changes in procedure definition may be presented to the user is displayed.

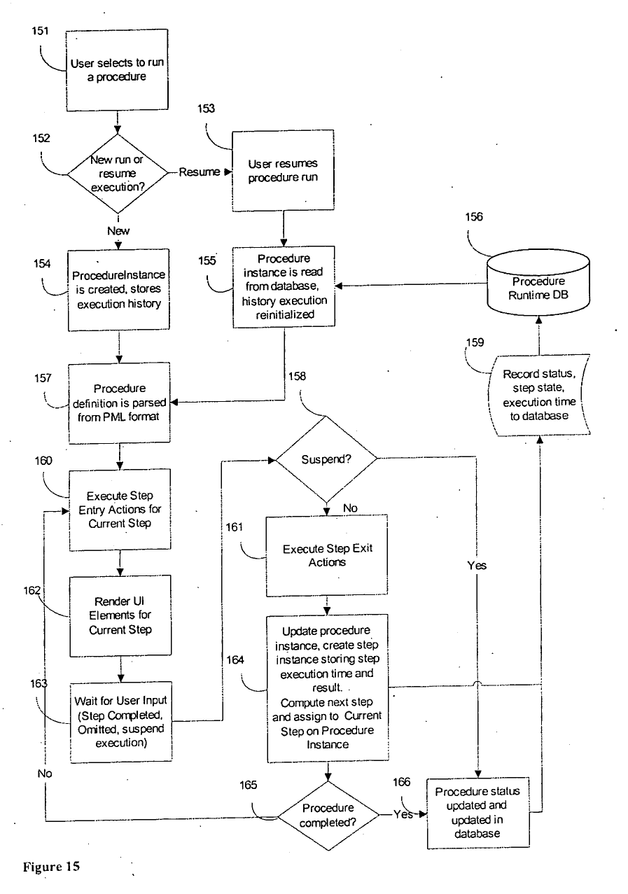

In another embodiment of the present invention a method is provided that allows users to suspend and later resume procedure execution. Users of the system may not get to complete a procedure run and need to resume procedure execution where they left off when they restart the process. The system ensures that users do not omit steps or redo steps of a procedure when it is restarted. When an active procedure is suspended, all relevant state information, including any previous responses and the attributes of any items in their workspace, is stored in the procedure runtime database. When the active procedure is resumed, all previously stored information is reloaded. The system assures that there is no loss of execution information. Referring now to FIG. 15, a flowchart of this process is outlined. The user of the system selects a procedure to use 151. The system provides a method to check if an existing instance of this procedure exists for this user in the system 152. The user is given the option to resume an existing run 153, in which case procedure instance data is initialized from the data read from the procedure instance database 155, or to create a new instance of the procedure, in which case the procedure instance data is created and initialized as a new instance for this procedure 154. The procedure instance that is created or reinitialized for this procedure stores the procedure execution history. By way of example, and without limitation, the instance data can capture information on the execution of procedure, including but not limited to, who ran the procedure, when the user ran it, the percentage of the procedure has been completed, steps that were started, completed and skipped, and any exceptions noted while running this instance of the procedure. The procedure structure stores this instance information 156, and makes it available for the purpose of auditing at a later stage. The current step is initialized, any step entry actions for the current step are executed 160 and the step is displayed to the user 162. By way of example, the user can mark the step as completed, skipped or stalled 163. If the user marks the step as completed, a step instance is created that records the state of the step as completed, the execution time of the step and result of the execution. This information is stored in the procedure runtime database 164. The percentage of the procedure that is completed is updated to reflect that this step was completed. The state of the step can also be marked as stalled, in which case the state and timestamp that the action occurred is recorded. The percent complete is not updated if the step is marked as stalled. The next step in the procedure definition is computed, and the procedure instance structure is updated to reflect the new current step 164. The algorithm checks after each step completion, if the last step has been completed 165, in which case the procedure is marked as done.

In yet another embodiment of the invention, another type of note is defined by the system. The system defines methods that allow the user to specify notes that are associated with the procedure instance or run of a procedure. The note may specify information relevant to this current run of the procedure. The information in the note is visible only to people who see this instance of the procedure. By way of illustration, and referring now to FIG. 9, this type of note is referred to as an activity note 91. The note could outline informational text on this procedure run, or could be used to note a variance that occurred while running this instance the procedure. The system defines methods that store these notes in the procedure runtime database. The notes are stored with the procedure usage information and methods are provided to retrieve and report on these notes. In this embodiment, a note will include note text 94 that the user enters and optionally can include attachments 95.

In this embodiment of the present invention, this procedure runtime information as outlined in previous embodiments is recorded to a procedure runtime database. By way of example, and without limitation, this audit data store can be a text file or a database. This database can be the same as the procedure definition database, or it can be a separate more secure database on a different machine, thus guaranteeing that the procedure runtime or auditable information is secure. By way of illustration, and without limitation, the runtime database maintains a record of what steps of each procedure defined in the system were performed, when they were performed and by whom they were performed. In addition, information on procedure start and complete times, steps that were skipped and any exceptions that were noted are saved to the runtime database. The information in this database can be viewed and analyzed at a later stage to see what steps of each procedure have been run and the results of this execution. The system provides methods to report off this runtime information that has been collected by the procedure management system. By way of example, and without limitation, reports on procedure usage, procedure outcome information and procedure log information are provided. A complete audit trail of step execution of each procedure in the system is available.

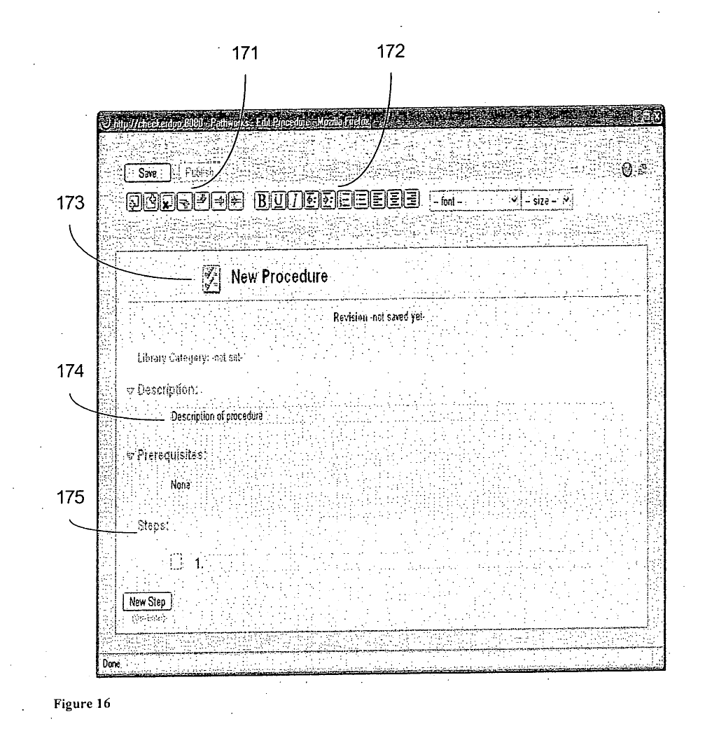

The system provides methods to author or capture procedure definitions in the system. By way of example and without limitation, one such method is a web based procedure creation application. The application presents an easy to use graphical interface to the user to enable them to define the procedure structure. Referring now to FIG. 16, one embodiment of such an application is displayed. Elements of the procedure structure include but are not limited to, the name 173 and description 174 of the procedure, and the steps 175 required to accomplish the procedure. The application provides methods to the user to easily add, delete or move steps of a procedure 171. By way of example, the steps of the procedure can be outlined in a tree like structure, allowing users to easily define steps and sub steps of the procedure. In addition the user can format the text of the procedure step 172. The system provides methods that will set the owner or author of the procedure, the date the procedure was created and last modified, the current version and the current state of the procedure. A procedure can have several defined states, including but not limited to, draft, current, or obsolete. A procedure in draft status cannot be used by the system; it is work in progress as the author works to make it accurate and current. A procedure is published once it is ready to be used and then becomes the current version. Once a procedure is published, the owner will determine who can use the procedure by moving it to an appropriate procedure category in the library. The authoring tool will enforce the security rules of procedure creation—authors are authenticated to ensure they have sufficient rights to create a new procedure in the procedure category they specify.

In yet another embodiment of the present invention, procedure structures are created from existing document files, including but not limited to DOC, TXT, HTML and the like. The ability to read this information and save as a procedure structure definition is provided. Users that have current procedure definitions in these existing document files are able to import these definitions and have them internally represented as procedure structures. By way of example, an XML schema template can be associated with a Microsoft Word document to define the elements of a procedure structure. The import utility will enable the user to import an existing Word document, and a wizard provides the ability to convert this document to a procedure structure definition. By way of example, and without limitation, this can include identifying the procedure owner, name, description, and the steps required running the procedure. The ability to save this procedure to the procedure definition database is provided. A mechanism to automatically identify the steps of a procedure is also provided. By way of example, and without limitation, steps can be represented as numbered lists, bulleted lists, indented lists, or paragraph types.

While the above is a description of the preferred embodiments of the invention, various alternatives, substitutions and modifications may be made without departing from the scope thereof, which is defined by the following claims. Thus, the preferred embodiments should not be taken as limiting the scope of the invention. Furthermore, the present invention is directed to a number of separate inventions and each of these inventions may be claimed independently of one another. Each feature, aspect and advantage of the invention may be claimed independent of one another without departing from the scope of the invention. Thus, the invention does not include a single essential feature, aspect or advantage and the invention should not be limited as such. It is intended, therefore, that the invention be defined by the scope of the claims which follow and that such claims be interpreted as broadly as is reasonable.

What is claimed is:

1. A procedure management system, comprising:
a host server configured to allow a user operating a web browser to define a procedure, the procedure having a name, a description and a list of steps required to achieve a specific task;
a procedure management server configured to process a procedure definition into a procedure structure that is retrievable by the host server and allow the user to run the procedure and provide feedback on the procedure definition; and
a database server including a run time database for procedure information and a definition database for procedures, the database server configured to communicate with the procedure management server.

2. The system of claim 1, wherein the host server is configured to allow a user operating a web browser to use and track the status of the procedures.

3. The system of claim 1, wherein the database server communicates with the procedure management server to store and retrieve procedure definition and run time information.

4. The system of claim 1, wherein the host server and the procedure management server are the same server.

5. The system of claim 1, wherein the database for procedure run time information and the procedure definition database are one database.

6. The system of claim 1, wherein the procedure definitions are selected from at least one of, procedure name, author, description of the procedure, date the procedure was created and last modified, a series of steps to accomplish the procedure, and embedded flow control based on step outcome that determines the next step of the procedure.

7. The system of claim 6, wherein a procedure can have more than one author.

8. The system of claim 6, wherein the procedure steps can include text.

9. The system of claim 8, wherein the procedure steps can include at least one of, screen shots, videos, attachments and sub-procedure links.

10. The system of claim 1, wherein a mark-up language outlines a structure for procedure definition information.

11. The system of claim 1, wherein the markup language is an XML document format, the structure of which is defined by an XML schema and the XML schema describes a structure and format of a procedure.

12. The system of claim 1, wherein the system is configured to enable collaboration on procedure content from different users of the system.

13. The system of claim 12, wherein a user of the system can enter procedure feedback on any step of a procedure definition.

14. The system of claim 13, wherein the procedure feedback can be specific to a step of a procedure or to the entire procedure definition.

15. The system of claim 13, wherein the user can determine if provided procedure feedback from the user is available to third parties.

16. The system of claim 13, wherein procedure feedback is displayed in line with the procedure definition to users of the system.

17. The system of claim 13, wherein a procedure owner can update the procedure in response to received procedure feedback.

18. The system of claim 13, wherein the system enables the procedure owner to respond to the procedure feedback.

19. The system of claim 13, wherein the server provides notification to the procedure owners when procedure feedback on a procedure is received.

20. The system of claim 19, wherein the system stores a list of procedure owners and sends out notification to procedure owners when feedback on a procedure is received.

21. The system of claim 19, wherein notification of procedure feedback to procedure owners is defined on a per-user basis.

22. The system of claim 21, wherein each procedure owner record includes information relative to how the procedure owner is notified of feedback.

23. The system of claim 1, wherein the system is configured to manage procedure definitions.

24. The system of claim 23, wherein XML content of a procedure definition is stored in the definition database for each revision of a procedure.

25. The system of claim 23, wherein the procedure management server tracks a current revision of a procedure and increments the revision each time a procedure is revised.

26. The system of claim 23, wherein the procedure management server stores a history of a procedure definition.

27. The system of claim 23, wherein the procedure management server permits viewing of a history of procedure definitions.

28. The system of claim 23, wherein the procedure management server retrieves revision information for each revision defined from the database and displays a list of available revisions to the user of system.

29. The system of claim 23, wherein the system permits a display of changes between selected revisions of a procedure.

30. The system of claim 1, wherein the system imports procedure definitions from external applications.

31. The system of claim 30, wherein procedure definitions can be read from the external application, converted into an XML format and stored in the definition database.

32. The system of claim 1, wherein the system is configured to provide testing of procedure definitions.

33. The system of claim 32, wherein the system can test procedure definitions before the procedure definitions are available to users of the system.

34. The system of claim 1, wherein the system is configured to read the procedure definitions from the procedure management server and display to a user of the system.

35. The system of claim 1, wherein the system tracks different instances of a procedure for each use of a procedure by users of the system.

36. The system of claim 35, wherein the procedure instance information is stored in the run time database.

37. The system of claim 1, wherein the system interactively guides the user through using the procedure.

38. The system of claim 37, wherein the system defines a set of available outcomes for each step of a procedure.

39. The system of claim 38, wherein the system presents a choice of step outcomes to the user.

40. The system of claim 39, wherein the system provides the user the ability to select step outcomes for each step of a procedure.

41. The system of claim 40, wherein the system tracks the outcome selected by the user for each defined step in a procedure during a procedure run.

42. The system of claim 41, wherein the step outcome for each defined step of each procedure instance is stored in the runtime database.

43. The system of claim 42, wherein a timestamp is stored in the run time database with each step outcome.

44. The system of claim 42, wherein the system tracks a percentage completion of each procedure to provide information to the user on procedure completion.

45. The system of claim 44, wherein procedure definition rules of step completion are enforced by the system.

46. The system of claim 1, wherein procedure runtime status information is displayed to the user of the system.

47. The system of claim 46, wherein the system displays step outcome information, timestamps for step outcomes and an overall view of procedure percent completion to the user.

48. The system of claim 47, wherein step outcome information and timestamps are retrieved from the run time database and displayed to the user.

49. The system of claim 1, wherein a user of the system can suspend and later resume a procedure run.

50. The system of claim 49, wherein procedure run time information related to the procedure run is stored in the run time database if the procedure is suspended.

51. The system of claim 50, wherein the procedure run information includes at least one of, step status, timestamps for all steps and current step in the procedure.

52. The system of claim 51, wherein the system provides for a resumption of any procedure run that has been suspended.

53. The system of claim 52, wherein the system displays a list of suspended procedure runs to the user of the system.

54. The system of claim 53, wherein the user can resume any item from the list of procedure instances in progress.

55. The system of claim 54, wherein the procedure run information is read from the run time database and the procedure structure is reinitialized upon resumption.

56. The system of claim 55, wherein the system displays the procedure to the user when the procedure structure is reinitialized.

57. The system of claim 56, wherein the system displays all step outcomes and timestamps recorded in the run time database relative to resumption.

58. The system of claim 57, wherein the user can resume execution of a procedure where the user left off.

59. The system of claim 58, wherein the system initializes a current step to the last step worked on as recorded in the database and displays this to the user.

60. The system of claim 1, wherein the system allows users to enter informational notes during an instance of a procedure run.

61. The system of claim 60, wherein the user can enter the informational notes at a step level or procedure level.

62. The system of claim 61, wherein the system provides for storage of informational notes in the run time database.

63. The system of claim 62, wherein the informational notes are visible only for this instance of the procedure run.

64. The system of claim 63, wherein the information notes can be read and displayed to the user when the procedure run is suspended and later resumed.

65. The system of claim 1, wherein an outcome of a procedure step triggers additional actions to be performed in the system.

66. The system of claim 1, wherein the system stores revisions of procedures used by a user.

67. The system of claim 66, wherein the system determines what version of a procedure was last used by a user.

68. The system of claim 67, wherein the system checks if a procedure version has changed since the user last used it.

69. The system of claim 68, wherein the system notifies the user if the procedure revision has changed since it was last run by the user.

70. The system of claim 69, wherein the system enables visual display of procedure definition changes to the user of the procedure if the system determines that the procedure has changed since it was last used.

71. The system of claim 70, wherein the user has the ability to hide or show changes in a procedure definition.

72. The system of claim 71, wherein the system presents the user with options to toggle the display of procedure changes.

73. The system of claim 68, wherein the system determines if a procedure in use has changed since the procedure was started by the user.

74. The system of claim 73, wherein the system updates the procedure to the latest version if selected by the user of the procedure.

75. The system of claim 1, wherein the system is configured to store information related to each procedure run in the runtime database.

76. The system of claim 75, wherein the system defines a procedure instance record for each procedure run.

77. The system of claim 76, wherein information that is stored is selected from at least one of, who performed what steps in each procedure, when the user performed the steps, step outcome of each step, and information notes associated with each step.

78. The system of claim 77, wherein the system is configured to enable users to run reports on procedure runtime data stored in the runtime database.

79. The system of claim 78, wherein the reports on procedure runtime data are selected from at least one of, procedure usage information and procedure outcome information.

80. The system of claim 1, wherein the system is configured to enable audits to be performed on the information from the runtime database.

81. The system of claim 1, wherein the system is configured such that a portion of the user's screen that is isolated from the rest of their desktop is reserved to display and run procedures.

82. The system of claim 1, wherein users of the system are defined and have user records.

83. The system of claim 82, wherein each user record contains information describing the user name, password and email address.

84. The system of claim 83, wherein each user record includes information selected from at least one of, user license type, group membership and application preferences.

85. The system of claim 84, wherein the user records are stored at the database server.

86. A method for allowing a user operating a web browser to define a procedure that has a name, a description and a list of steps required to achieve a specific task, comprising:
defining each step of a procedure; and
storing the procedure definition in database.

87. A method for allowing a user to display a procedure, comprising:
downloading the procedure by the user; and
displaying the procedure to the user.

88. A method for allowing a user to use and track the outcome of a procedure, comprising:
downloading the procedure by the user;
running the procedure by the user;
allowing the user to track the outcome of each step of the procedure.

89. The method of claim 88, further comprising:
defining a procedure instance record for each procedure run.

90. The method of claim 89, further comprising:
tracking different instances of a procedure for each use of a procedure by users.

91. The method of claim 90, further comprising:
storing and retrieving procedure run time or instance information.

92. The method of claim 88, further comprising:
interactively guiding the user through using the procedure.

93. The method of claim 92, further comprising:
defining a set of available outcomes for each step of a procedure;
presenting a choice of step outcomes to the user; and
allowing the user to select step outcomes for each step of the procedure.

94. The method of claim 93, further comprising:
tracking an outcome selected by the user for each defined step in a procedure during a procedure run.

95. The method of claim 94, further comprising:
checking an order and the properties of each step of a procedure.

96. The method of claim 92, further comprising:
allowing the users to enter informational notes during an instance of a procedure run.

97. The method of claim 94, further comprising:
performing an audit on procedure information from a runtime database.

98. A method for allowing a user to suspend and later resume a procedure run, comprising:
recording procedure instance data in the database on suspension; and
reloading data and reinitializing procedure structure on resumption.

99. A method for allowing collaboration on procedure content from different users, comprising:
displaying the procedure to the user;
entering procedure feedback on any step of a procedure definition; and
determining if provided procedure feedback from the user is available to third parties.

100. The method of claim 99, further comprising:
notifying the procedure owner of feedback;
updating the procedure content in response to received procedure feedback; and
storing the updated procedure definition in the database.

101. A method for allowing management of procedure definitions, comprising:
tracking the current revision of a procedure; and
incrementing a procedure revision number when a new revision of a procedure is revised.

102. The method of claim 101, further comprising:
storing a history of a procedure definition.

103. The method of claim 101, further comprising:
retrieving revision information for each revision of a procedure; and displaying a list of available revisions to the user.

104. The method of claim 101, further comprising:
displaying changes between selected revisions of a procedure.

105. The method of claim 101, further comprising:
determining what version of the procedure last used by the user; and
displaying procedure differences to the user if the procedure has changed.

106. A method for allowing procedures to be read into the system, comprising:.
importing procedure definitions from external applications.

107. A method to enable procedures to be tested in the system before they are available for use, comprising:
testing procedure definitions before the procedure definitions are available to users.
